(19) United States
(12) Patent Application Publication
(10) Pub. No.: US 2016/0288440 A1
(43) Pub. Date: Oct. 6, 2016

(54) APPARATUS AND METHOD FOR CUSTOM MOLDING AN INSOLE

(71) Applicant: Zero Gravity Inside, Inc., National City, CA (US)

(72) Inventor: Patrik Louko, Helsinki (FI)

(21) Appl. No.: 14/675,523

(22) Filed: Mar. 31, 2015

(51) Int. Cl. B29D 35/12; A43B 17/00; A43B 17/14; B29D 35/14

(52) U.S. Cl. CPC B29D 35/128; B29D 35/142; A43B 17/006; A43B 17/14; B29K 2995/007

(57) ABSTRACT

A molding device is disclosed. In one aspect, the molding device includes a foam layer, a gel layer placed over the foam layer, and a flexible cover configured to enclose the foam layer and the gel layer, wherein the flexible cover comprises a movable portion and an intermediate portion placed below the movable portion, wherein the intermediate portion is placed between a portion of the gel layer and a portion of the foam layer, and wherein the flexible cover includes a surface that contacts a top of the gel layer, wherein the gel layer is configured to elastically support the shoe insole via the surface of the flexible cover, and wherein the movable portion is configured to move the portion of the gel layer between a first position where the movable portion contacts the intermediate portion and a second position where the movable portion is separated from the intermediate portion.

### RELATED APPLICATIONS

This application is related to i) the U.S. patent application entitled “Moldable Footwear Insole” (Attorney Docket No. ZGI.002A) and ii) the U.S. patent application entitled “System and Method for Reproducing Molded Insole” (Attorney Docket No. ZGI.004A) concurrently filed with this application, both of which are incorporated herein by reference.

### BACKGROUND

1. Field

The described technology generally relates to a molding device and a method of use thereof to produce a custom molded insole.

2. Description of the Related Technology

A shoe insole or insole refers to an insert with a cushion layer which is fitted into a shoe. Insoles are widely used to provide support and comfort for a user's foot. To provide optimized comfort to a specific foot, custom-made insoles have been developed that conform to the unique and specific shape of a user's foot. In general, custom insoles can be made by molding insoles using a person's feet. These customized insoles are generally more comfortable than mass produced insoles.

### SUMMARY

The apparatuses and systems of the present disclosure have several features, no single one of which is solely responsible for its desirable attributes. Without limiting the scope of the described technology as expressed by the claims which follow, its more prominent features will now be discussed briefly. After considering this discussion, and particularly after reading the section entitled “Detailed Description,” one will understand how the features of this disclosure provide several advantages over current insole molding technologies.

In one aspect, a molding device includes a foam layer, a gel layer placed over the foam layer, and a flexible cover configured to enclose the foam layer and the gel layer, wherein the flexible cover includes a movable portion and an intermediate portion placed below the movable portion, wherein the intermediate portion is placed between a portion of the gel layer and a portion of the foam layer, and wherein the flexible cover includes a surface that contacts a top of the gel layer, wherein the gel layer is configured to elastically support the shoe insole via the surface of the flexible cover, and wherein the movable portion is configured to move the portion of the gel layer between a first position where the movable portion contacts the intermediate portion and a second position where the movable portion is separated from the intermediate portion.

Another aspect is a method of custom molding a shoe insole including placing the insole on a molding device, wherein the molding device includes a foam layer, a gel layer, and a flexible cover, first pressing the insole between a user's foot and a surface of the molding device with the molding device in a first position, wherein the surface contacts a top of the gel layer; and second pressing the insole between the user's foot and the surface of the molding device with the molding device in a second position different from the first position. In some aspects the method further includes heating the insole to a temperature in the range of approximately 120° C. and approximately 140° C. for between about three minutes and about five minutes;

Another aspect is a shoe insole molded by the above method.

Another aspect is a molding device for molding a shoe insole including a gel layer and a flexible cover configured to enclose the gel layer, wherein the flexible cover includes a surface that contacts a top of the gel layer, wherein the gel layer is configured to elastically support the shoe insole via the surface of the flexible cover.

### BRIEF DESCRIPTION OF THE DRAWINGS

The above mentioned and other features of this disclosure will now be described with reference to the drawings of several embodiments of the present molding device and method of use thereof. The illustrated embodiments of the apparatuses and methods are intended to illustrate but not to limit the disclosure Like reference numerals refer to like elements throughout the detailed description. The drawings contain the following figures:

FIG. 1 is a conceptual drawing that illustrates a method for custom molding an insole using a molding device according to one embodiment.

FIGS. 2A and 2B show top and bottom views, respectively, of a pair of example insoles that can be molded to conform to the specific shape of a user's foot with example molding devices and methods described herein according to one embodiment.

FIGS. 3A and 3B show perspective views of an example molding device including a moveable portion in a first position and a second position, respectively, according to one embodiment.

FIGS. 3C and 3D show side views of the molding device of FIGS. 3A and 3B with the movable portion in the first position and the second position, respectively.

FIG. 3E shows a top view of the molding device of FIGS. 3A and 3B with a movable portion shown in the first position.

FIG. 4 depicts example interior layers of the molding device according to one embodiment.

FIG. 5 is a side view of the molding device that illustrates the placement of each of the internal layers within the cover according to one embodiment.

FIG. 6A shows an example molding stand including two molding devices, according to one embodiment.

FIG. 6B is a cross-sectional view of the molding stand of FIG. 6A and illustrates the placement of the molding devices within the molding stand.

FIG. 7 is a flowchart depicting an example method of using a molding device as described herein to custom mold a moldable insole according to one embodiment.

FIGS. 8A through 8C illustrate comparison of a user's foot to a selected insole to determine whether a properly sized insole has been selected.

FIG. 9 illustrates an example heater configured to heat the insoles according to one embodiment.

FIGS. 10A through 10C illustrate proper and improper insertion of moldable insoles into the heater according to one embodiment.

FIG. 11 illustrates an example of the relative positioning of a user, a heated moldable insole, and a molding device in preparation for molding the moldable insole according to one embodiment.

FIG. 12 provides a detailed view of the alignment of a heated moldable insole on a molding device according to one embodiment.

FIGS. 13A and 13B illustrate the use of an example heel alignment guide on the moldable insole to properly align the user's foot relative to the moldable insole during the molding process according to on embodiment.

FIG. 14 illustrates an example positioning of a user with weight shifted to his or her heels during some portions of the molding process according to one embodiment.

FIG. 15 illustrates an example positioning of a user and the molding device with a movable portion in the second position during some portions of the molding process according to one embodiment.

FIGS. 16A and 16B illustrate the use of an example quality control tool to check that the heel portion of a molded insole is properly aligned and level according to one embodiment.

### DETAILED DESCRIPTION

Embodiments will be described with respect to the accompanying drawings. Like reference numerals refer to like elements throughout the detailed description. In this disclosure, the term “substantially” includes the meanings of completely, almost completely or to any significant degree under some applications as understood by those skilled in the art.

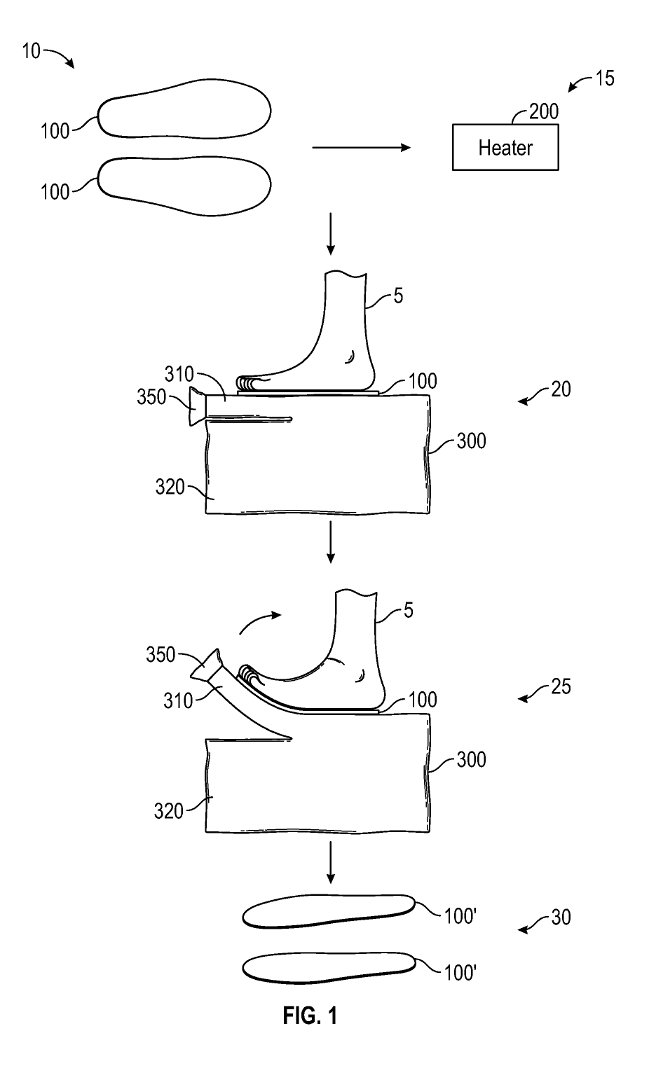

FIG. 1 is a conceptual drawing that illustrates a method 10 for molding a non-molded insole 100 (hereinafter to be interchangeably used with non-molded insoles 100) to produce a custom molded insole 100′ using a molding device 300 according to one embodiment. The method 10 the uses non-molded insoles 100, a heater 200, and the molding device 300 to mold the non-molded insoles 100 to conform to the unique shape of a user's foot 5.

The method 10 begins at step 15 with selection of a pair of non-molded insoles 100, one for each of a user's feet 5. Each of the insoles 100 may include at least one rigid layer that becomes pliable upon heating. At step 15, the selected non-molded insole 100 is inserted into the heater 200 and heated until the at least one rigid layer becomes pliable.

At step 20, the heated insole 100 is removed from the heater 200 and placed on a top surface of the molding device 300. The user's foot 5 is then placed on top of the heated insole 100. As the foot 5 presses the heated insole 100 into the molding device 300, the heated insole 100 substantially conforms to the specific musculoskeletal shape of the foot 5. As shown in step 20, the molding device 300 includes a moveable portion 310 resting on top of a fixed portion 320. This position of the movable portion 310 of the molding device 300 is referred to as the first position throughout this application. The molding device 300 can mold at least the rearfoot and/or midfoot portion of the insole 100 in the first position. In some embodiments, the user leans back, placing his or her weight on her heels to mold a portion of the insole 100 with the movable portion 310 of the molding device 300 in the first position.

At step 25, the movable portion 310 of the molding device 300 is moved into a second position as shown. When the movable portion 310 is in the second position, the moveable portion 310 can be pulled up away from the fixed portion 320 and toward a user's shin. The molding device 300 includes a handle 350 attached to a distal end of the moveable portion 310 that can be gripped to move the moveable portion 310 into the second position as described. The molding device 300 can mold at least a forefoot and/or midfoot portion of the insole 100 with the movable portion 310 in the second position.

Step 25 can be performed substantially close in time to step 20, either before or after. In some embodiments, step 25 follows immediately after or precedes immediately before step 20 such that the heated insole 100 remains substantially pliable during step 20 and step 25. Moreover, in some embodiments, the foot 5 is not repositioned on the heated insole 100 or molding device 300 between step 20 and 25 (other than the movement of the insole 100 and foot 5 as the movable portion 310 of the molding device 300 is moved from the first position to the second position, or vice versa).

Method 10 concludes at step 30, where the now molded insole 100′ is removed from between the user's foot 5 and the molding device 300 and allowed to cool. As the rigid layer of the molded insole 100′ cools, it returns to its substantially rigid state and holds its newly molded shape. Accordingly, method 10 allows a user to mold a non-molded insole 100, with a general shape, into a molded insole 100′ with a specific shape that conforms substantially to the unique shape of the user's foot 5.

In some embodiments, the method 10 is repeated for each of a user's feet 5. A single insole 100 (for example, for the right foot) can be heated, molded to the user's foot 5 with the movable portion 310 of the molding device 300 in the first position and in the second position, and allowed to cool, and then the process can be repeated again for the other insole 100 (for example, for the left foot). In some embodiments, both insoles 100 (left and right) are heated together and molded separately. For example, both insoles 100 can be heated at the same time, one insole 100 can be molded using the molding device 300 with the movable portion 310 in the first and second positions, and then the other insole 100 can be molded using the molding device 300 in the first and second positions. In some embodiments, the insoles 100 are heated and molded together, for example, using a single molding device 300 wide enough to simultaneously accommodate both of a user's feet 5, or two narrower molding devices 300 placed side by side. The specific details and devices of method 10 will now be discussed in greater detail below.

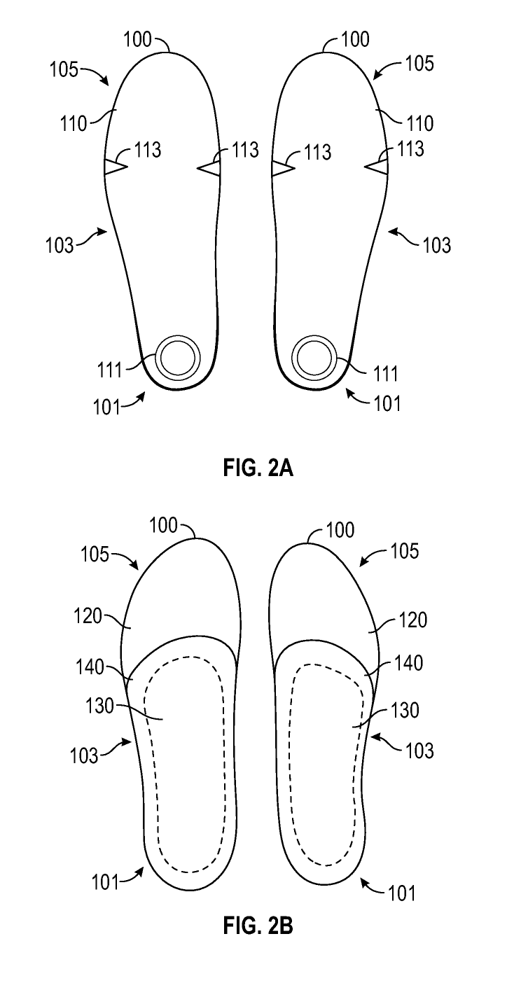

FIGS. 2A and 2B show top and bottom views, respectively, of a pair of example insoles 100 that can be molded to conform to the specific shape of a user's foot 5 with embodiments of the molding devices 300 and methods described herein according to one embodiment. The following description of FIGS. 2A and 2B is applicable to insoles 100 in both a molded or non-molded state.

Each pair of insoles 100 includes a right and a left insole 100, each shaped generally with a profile configured to substantially follow the shape of a user's left and right foot, respectively. Each insole 100 includes a rearfoot or heel area 101, midfoot or arch area 103, and a forefoot or toe area 105 as shown. In some embodiments, the insoles 100 are made from one or more layers. For example, as shown in FIGS. 2A and 2B, the insoles 100 are made from four layers. Each of the insoles 100 includes a cover layer 110 placed on top of a foam layer 120, a rigid layer 130, formed of a heat-moldable material, placed below the foam layer 120, and a base layer 140 covering the rigid layer 130. In some embodiments, the cover layer 110 and the foam layer 120 extend under the entirety of the user's foot 5, for example, from the rearfoot area 101 to the forefoot area 105. In some embodiments, the rigid layer 130 and the base layer 140 extend only under the rearfoot area 101 and at least a portion of the midfoot area 103 (or, in other words, in some embodiments, the rigid layer 130 and base layer 140 do not extend under the toe area 105 of the insole 100).

The rigid layer 130 of the insole 100 can be made from a heat-formable or thermoplastic material, such as a glycol-modified polycyclohexylenedimethylene terephthalate copolymer (PCTG), ABS, PVC, A-PET, PETG, or another suitable material that is (1) substantially rigid throughout a range of temperatures at which the insole 100 will be used, for example, the range of temperatures typical within a user's shoe, and (2) substantially pliable or moldable throughout a range of temperatures that will be used during the molding process, for example, temperatures in the range of about 120 to about 140° C. In some embodiments, the material of the rigid layer 130 is pliable at temperatures which allow the heated insole 100 to be pressed against a user's foot 5 while still in a pliable state without burning or injuring the user. In some embodiments, the foam layer 120 and the cover layer 130 provide sufficient insulation to protect a user's foot 5 during molding.

In some embodiments, as shown in FIG. 2A, the cover layer 110 also includes one or more heel alignment guides 111, configured to aid a user in correctly locating his or her heel relative to the insole 100 during molding. Moreover, additional alignment guides 113 are present on the cover layer 111 which may be used to help align the insole 100 relative to the molding device 300 during the molding process. However, some or all of the elements 111 and 113 can be omitted.

A detailed description of an example moldable insole that can be used with the devices and methods described herein is provided in the U.S. patent application entitled “Moldable Footwear Insole” (Attorney Docket No. ZGI.002A) that is concurrently filed herewith and is incorporated herein by reference. It should be noted, however, that the molding devices and methods described herein may be usable with other types of moldable insoles.

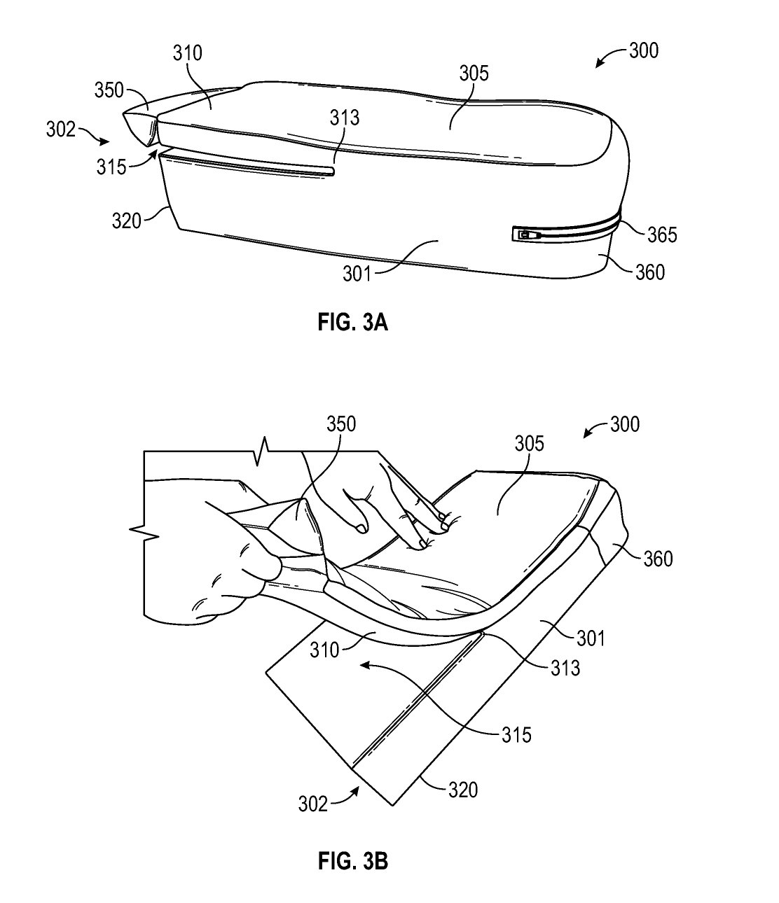

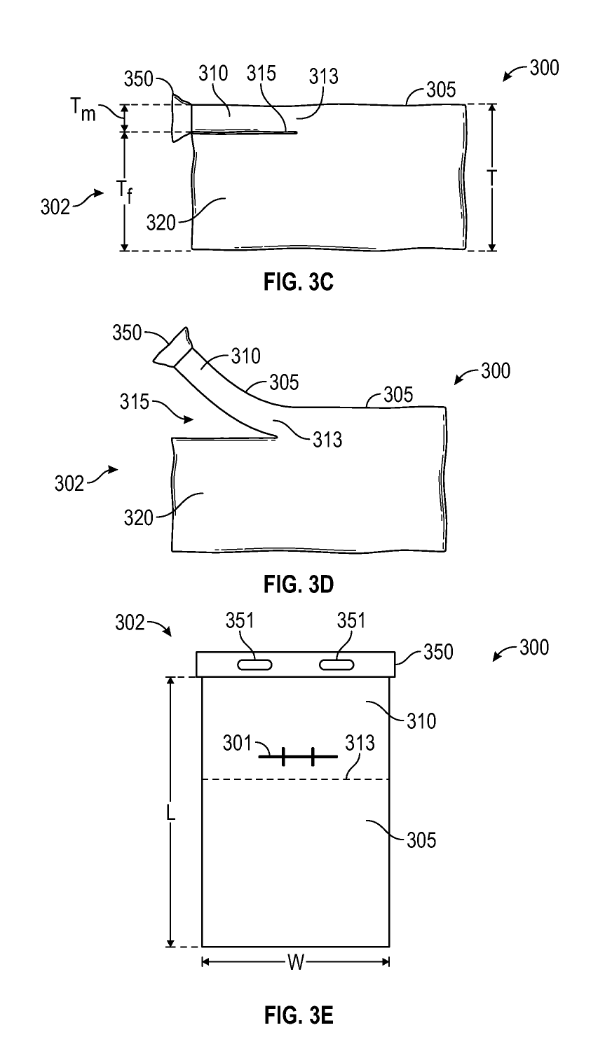

FIGS. 3A through 3E show various views of an example molding device 300 according to one embodiment. Specifically, FIGS. 3A and 3B show perspective views of the molding device 300 including a moveable portion 310 in a first position and a second position, respectively. FIGS. 3C and 3D show side views of the molding device 300 shown with the movable portion 310 in the first position and the second position, respectively. FIG. 3E shows a top view of the molding device 300 with a movable portion 310 shown in the first position. Depending on the specific embodiments, certain elements may be removed from or additional elements may be added to the molding device 300 illustrated in FIGS. 3A through 3E. Furthermore, two or more elements may be combined into a single element, or a single element may be realized as multiple elements.

The molding device 300 shown in FIGS. 3A and 3B includes a body 301 shaped as a rectangular prism, although other shapes may be used without departing from the scope of this disclosure. The body 301 is configured to support the insole 100 and the foot 5 during the molding process. The insole 100 can be placed on a top surface 305 of molding device 300 and the foot 5 is placed on top of the insole 100.

The body 301 of the molding device 300 may include one or more internal layers of gel and one or more internal layers of foam, as will be described below, placed within a flexible cover 360. Accordingly, as a user steps onto the top surface 305 of the molding device 300, the user's foot presses into the body 301 of the molding device 300, and the top surface 305 of the molding device 300 conforms substantially to the specific shape of the bottom surface of the user's foot 5. The insole 100, pressed between the foot 5 and the molding device 300, is therefore molded to conform to the shape of the foot 5.

A front or distal portion 302 of the body 301 of the molding device 300 is divided between a moveable portion 310 and a fixed portion 320 separated by a gap 315. The movable portion 310 can be configured as a flap and attached to the rest of body 301 at a proximal end of the movable portion 310 at a hinge region 313. A handle 350 can be provided at a distal end of the movable portion 310 and configured such that a user can grip the handle 350 and pull the movable portion 310 up away from the fixed portion 320, thereby increasing the size of gap 315. In some embodiments, the movable portion 310 connects to the fixed portion 320 at approximately the location where the ball of a foot is placed during molding. In some embodiments, the length of the moveable portion 310 is approximately one-third the total length of the molding device 300.

FIGS. 3A and 3C show the molding device 300 with the movable portion 310 in the first position. In the first position, the moveable portion 310 rests substantially on top of and is supported by the fixed portion 320, and the gap 315 is substantially small. In some embodiments, a lower surface of the movable portion 310 rests directly on top of a top surface of the fixed portion 320 such that the gap 315 is substantially closed. With the movable portion 310 in the first position, the top surface 305 of the molding device 300 has a substantially horizontal planar shape. Accordingly, in this position, the molding device 300 provides a flat molding surface.

FIGS. 3B and 3D show the molding device 300 with the movable portion 310 in the second position. In the second position, the moveable portion 310 is pulled up and away from the fixed portion 320 and the gap 315 is substantially open. Because the moveable portion 310 is attached to the body 301 at the hinge region 313, in the second position, the moveable portion 310 is substantially positioned at an angle relative to the plane of the top surface 305 in the first position. In some embodiments, the moveable portion 310 curves up and away from the body 301. The molding device 300, with the movable portion 310 in the second position, provides a molding surface configured to conform to the shape of a user's foot 5 with the toes in extension.

As shown in FIG. 3C, the molding device 300 may have an overall thickness T. In some embodiments, the overall thickness T is between approximately 30 mm and approximately 200 mm. In some embodiments, the overall thickness T is approximately 100 mm. For a front or distal portion 302 of the molding device 300, the overall thickness T is divided between the thickness of the moveable portion 310, Tₘ, and the thickness of the fixed portion 320, T_{f}. In some embodiments, the thickness Tₘ is substantially half or less than half the thickness of T_{f}. For example, in some embodiments, Tₘ is approximately 30 mm and T_{f} is approximately 70 mm. However, the described technology is not limited to the above ranges and other thicknesses for T, Tₘ, and T_{f} are possible. As will be explained below, the thicknesses of Tₘ and T_{f} may correspond to the thicknesses of the individual layers that make up the internal structure of the molding device 300.

The molding device 300 has an overall length L and an overall width W as shown in FIG. 3E. The length L and width W define the overall shape of the molding device 300. As shown, the molding device 300 may be substantially rectangular, although other shapes are possible as long as the shape provides adequate space for an insole 100 and user's foot 5 to be received thereon. In some rectangular embodiments, each of the length L and the width W may be in the range of approximately 150 mm and approximately 400 mm. However, other lengths and widths are possible, for example, as long as the length L and width W are sufficient to accommodate the entire length of a user's foot 5 and provide some clearance space (for example, at least 10 mm) around the foot 5. The width W can be configured such that the molding device 300 is suitable for use with only a single foot 5 at a time. The width W can further be configured such that the molding device 300 is suitable for use with both feet 5 at the same time.

In some embodiments, as shown in FIG. 3E, the top surface 305 of the molding device 300 includes one or more alignment guides 307 that aid a user in placing the insole 100 correctly on the molding device 300. The alignment guides 307 may be markings corresponding to other alignment guides (for example, front alignment guides 113 as seen in FIG. 2A) on the cover layer 130 of the insole 100. For example, in some embodiments, the user may be instructed to align front alignment guides 113 on the cover layer 110 with the alignment guides 307 on the top surface 305 of the molding device 300. This may help ensure that the insole 100 is correctly aligned on the molding device 300 so as to correctly be molded when the movable portion 310 of the molding device 300 is in the second position.

In some embodiments, as shown in FIG. 3E, the handle 350 of the molding device 300 includes one or more holes 351 extending through the handle 350. The holes 351 can be configured to make the handle 350 easier to grip.

In some embodiments, as seen in FIGS. 3A and 3B, the molding device 300 includes a cover 360 configured to surround the internal components of the molding device 300. The cover 360 can be made from any typical flexible fabric, such as flexible cloth. In some embodiments, the cover 360 is made from a thin, elastic cloth, for example Spandex. The particular shape of the cover 360 will become apparent as the internal components of the molding device 300 are described below.

The cover 360 may be configured to be removable. As seen in FIG. 3A, in some embodiments, the cover 360 includes a zipper 365 extending around a back surface of the molding device 300. The cover 360 may use other closure mechanisms. For example, the cover 360 may include one or more openings that use Velcro, buttons, snaps, toggles, magnets, zippers, or any other suitable closure mechanism. In some embodiments, the cover 360 includes openings that do not use any closure mechanism. For example, the cover 360 may include an opening that includes overlapping flaps. In some embodiments, the cover 360 does not include any opening and may not be removable. In some embodiments, no cover is used.

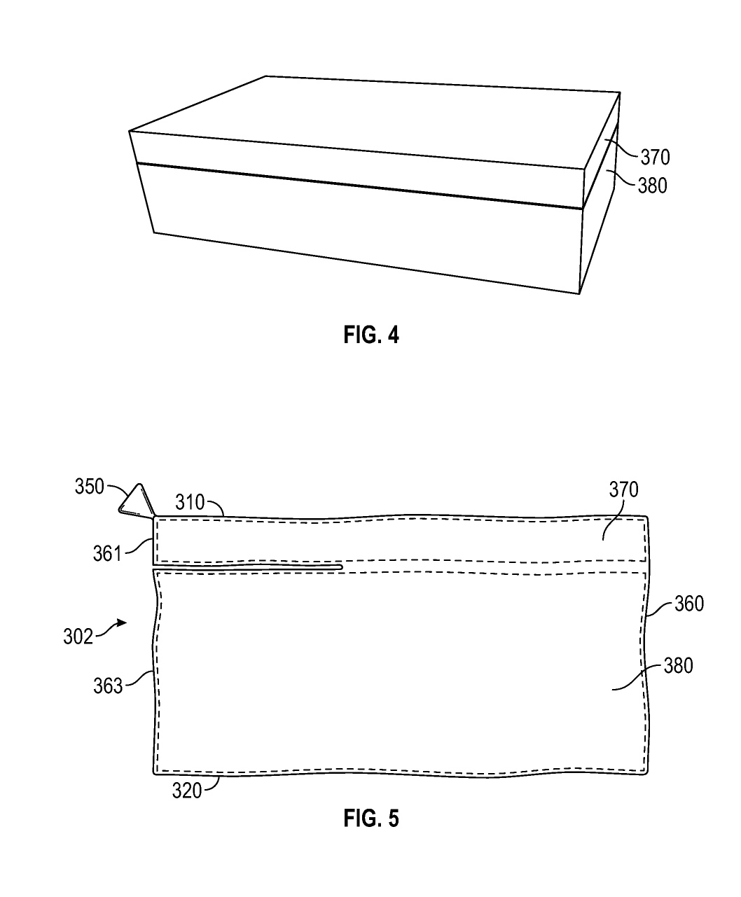

FIG. 4 depicts example interior layers of the molding device 300 according to one embodiment. In the embodiment shown, the molding device 300 includes two layers: a gel layer 370 and a foam layer 380.

The gel layer 370 is placed directly below the top surface 305 of the molding device 300. Accordingly, the gel layer 370 is the structure within the molding device 300 that allows the molding device 300 to accurately mold the insoles 100 to the specific shape of a user's foot 5. In some embodiments, the gel layer 370 provides a liquid pressure effect against the bottom and sides of the foot during molding. That is, in some embodiments, the gel layer 370 provides a substantially or significantly uniform pressure around the sides of the foot, as well as on the bottom of the foot. The gel layer 370 may allow a more accurate molding of a heel cup region of the insole 100 by providing uniform molding pressure around the heel as high as 2 cm to about 4 cm above the bottom of the insole 100. Similarly, the gel layer 370 may allow for a higher formed arch and a more generally contoured molded insole 100. The gel layer 370 may be made from a gel or foam material with a density and/or hardness comparable to the hardness of muscle tissue. For example, in some embodiments, the gel layer 370 is formed from a silicon rubber or other suitable material with a Shore hardness of in the range of about 00-40 and about 00-05. In some embodiments, the gel layer is formed from Ecoflex® Supersoft 0010, Ecoflex® Supersoft 0020, or Ecoflex® Supersoft 0030 available from Smooth-On, Inc., of Macungie, Pa.

The foam layer 380 is placed below the gel layer 370. The foam layer 380 supports the gel layer 370, for example, by providing a sturdy, compressible base for the molding device 300. The foam layer 380 can be made from a stiff, deformable viscoelastic foam, such as memory foam. In some embodiments, the foam layer 380 is made at least partially from a polyurethane material that has viscoelastic property. Preferably, in some embodiments, the foam layer 380 should be just pliable to enough to allow the gel layer 370 to contour to the bottom of the user's foot 5 when the user stands on the molding device 300. Preferably, in some embodiments, the foam layer 380 is as stiff as possible while still allowing deformation sufficient to allow the gel layer 370 to contour to the entire bottom surface of a user's foot 5 and at least a portion of the side surface of the foot. In some embodiments, the foam layer 380 may deform in the range of between about 0.1 inches to about 1.0 inch when a user stands on the molding device 300. In some embodiments, the combined deformation of the gel layer 370 and the foam layer 380 is sufficient to allow the top surface 305 to conform to the shape of the arch of the foot 5 when the user stands on the molding device 300. In some embodiments, each of the gel layer 370 and/or the foam layer 380 includes one or more layers.

Each of the gel layer 370 and the foam layer 380 can be configured in size and shape to fit within the cover 360. Accordingly, the gel layer 370 and the foam layer 380 may each have a length and a width that correspond to the overall length L and width W of the molding device 300 described above in reference to FIG. 3E. Moreover, the thicknesses of gel layer 370 and the foam layer 380 may correspond to the thicknesses of the moveable portion 310, Tₘ, and the fixed portion 320, T_{f}, respectively.

FIG. 5 is a side view of the molding device 300 that illustrates the placement of each of the internal layers 370, 380 within the cover 360 according to one embodiment. As shown, the cover 360 is configured to substantially surround the gel layer 370 and the foam layer 380. At the distal end 302, the molding device 300 is divided into the moveable portion 310 and the fixed portion 320 as described above. The cover 360 includes a movable pocket 361 and a fixed pocket 363 as shown. The foam layer 380 may be inserted into the bottom portion of the cover 360 and a distal end of the foam layer 380 may be placed within the fixed pocket 363, forming the fixed portion 310. Similarly, the gel layer 370 may be inserted into the top portion of the cover 360 above the foam layer 370. A distal end of the gel layer 370 may be placed within the moveable pocket 361 of the cover 360, forming the movable portion 310. Accordingly, a top portion of the fixed pocket 363 and a bottom portion of the moveable pocket 361 are located between the distal ends of the foam layer 380 and the gel layer 370. The proximal ends of the foam layer 380 and the gel layer 370, in some embodiments, are placed directly on top of each other.

A portion of the gel layer 370 may be placed within the fixed pocket 363. For example, the distal end of the gel layer 370 is split with a top portion placed within the moveable pocket 361 and a bottom portion placed within the fixed pocket 363. Or, for example, the gel layer 370 includes two or more layers, with a top layer placed within the moveable pocket 361 and a bottom layer placed within the fixed pocket 363. Similarly, a portion of the foam layer 380 may be placed within the movable pocket 361. For example, the distal end of the foam layer 380 is split with a top portion with a top portion placed within the moveable pocket 361 and a bottom portion placed within the fixed pocket 363. Or, for example, the foam layer 380 includes two or more layers, with a top layer placed within the moveable pocket 361 and a bottom layer placed within the fixed pocket 363.

The layers placed within the movable pocket 361, that accordingly include the movable portion 310 of the molding device 300, are sufficiently pliable to allow movement of the movable portion 310 of the molding device 300 between the first and second positions as described above. The movable portion 310 allows the molding device 300 to more accurately mold the forefoot and/or midfoot portions of the insole 100.

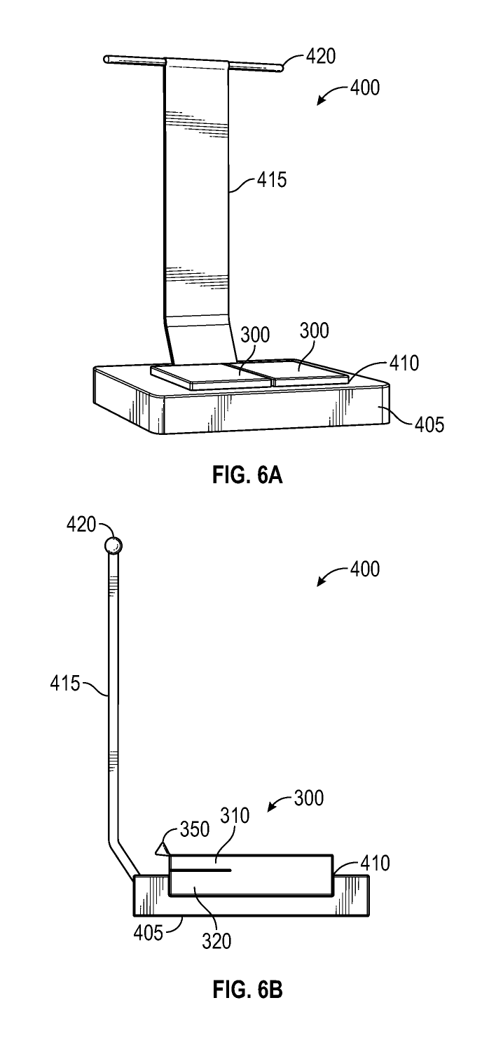

FIG. 6A shows an example molding stand 400 including two molding devices 300 according to one embodiment. The molding stand 400 includes a base 405 configured to rest on the ground and support one or more molding devices 300 therein. In some embodiments, the base 405 includes one or more recesses 410 formed in a top surface of the base 405. The base 405 can include a single recess 410 configured to hold a single molding device 300 or two (or more) molding devices 300 side by side. The base 405 may include more than one recess 410, each recess configured to hold a single molding device 300. The base 405 may support one or more molding devices 300 above the ground such that a user may easily step up and onto the molding devices 300 in the base 405 of the molding stand 400.

A vertical support 415 can extend upward from the base 405 and provide a handle 420 that users can use to support and balance themselves during the molding process. In some embodiments, the vertical support 415 extends up and away from an outer edge of the base 405 such that the handle 420 is positioned substantially in front of a user standing on the molding stand 400. The handle 420 can be positioned between three and four feet above the base 405. In some embodiments, the vertical support 415 is adjustable, such that the height of the handle 420 can be adjusted to accommodate users of different heights.

FIG. 6B is a cross-sectional view of the molding stand 400 of FIG. 6A and illustrates the placement of the molding devices 300 within the molding stand 400. As shown, the molding device 300 rests within the recess 410 of the base 405. In some embodiments, the movable portion 310 is placed substantially above the top surface of the base 405. This may facilitate use of the molding device 300. For example, it may make it easier to grab the handle 350 and move the movable portion 310 of the molding device 300 from the first position to the second position. In some embodiments, however, the top surface 305 of the molding device 300 may be level with (or even below) the top surface of the base 300.

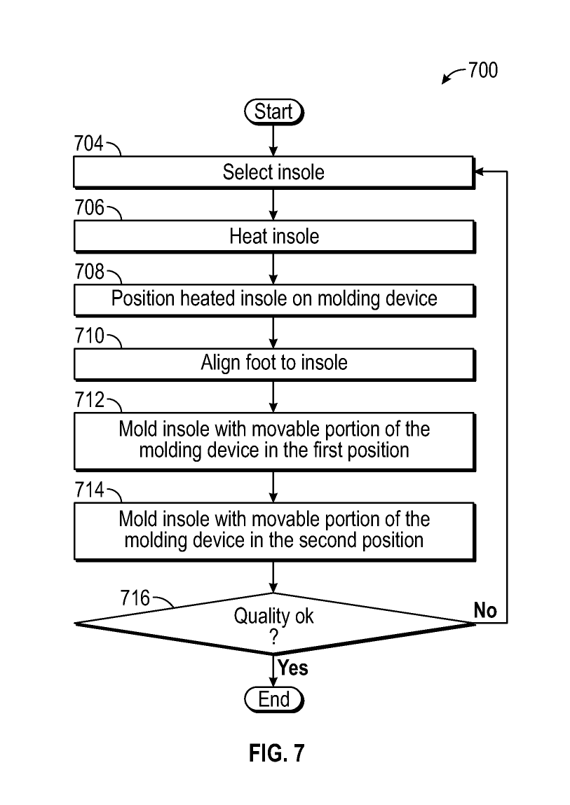

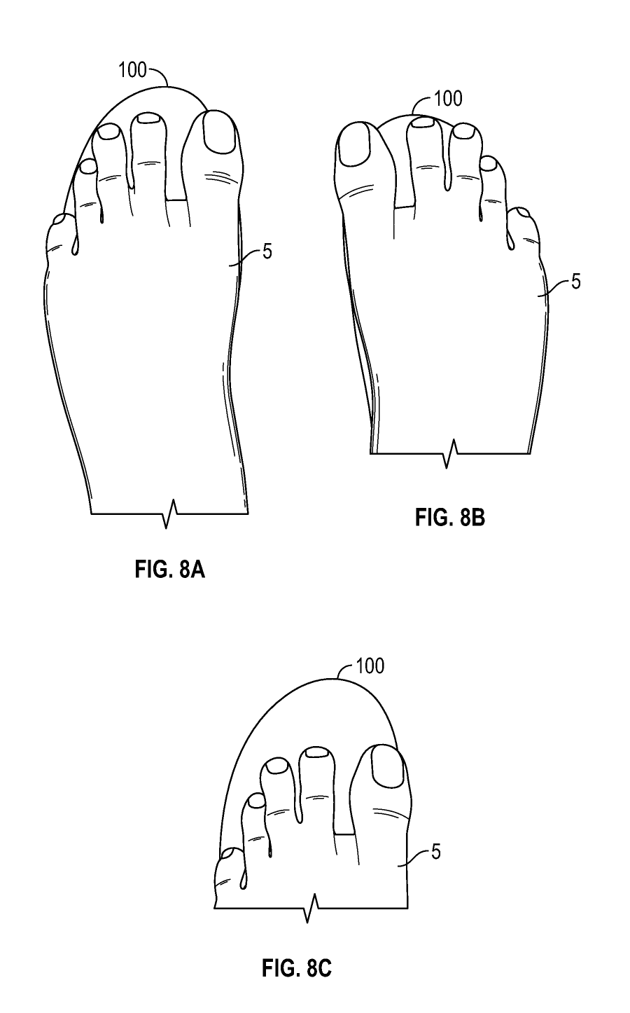

FIG. 7 is a flowchart depicting an example method 700 of using a molding device 300 as described herein to custom mold an insole 100 according to one embodiment. Method 700 describes in detail the molding method 10 discussed at a conceptual level above in reference to FIG. 1. Depending on the specific embodiment, additional steps may be added, others removed, or the order of the steps changed in the method 700. The method 700 will now be described in detail with reference to FIG. 7 as well as the specific examples and embodiments illustrated in FIGS. 8A-16B.

The method 700 may be performed in a retail establishment, for example, a sporting goods store, runner specific athletic store, or other shoe store. Accordingly, in some embodiments, the user may be customer visiting a retail establishment to obtain a pair of custom molded insoles 100. An employee or clerk of the retail establishment may assist the user in custom molding a pair of insoles 100 using the method 700 described herein. In another embodiment, a medical professional, for example a doctor or physical therapist, may assist the user in custom molding a pair of insoles 100.

At block 704, a non-molded insole 100 is selected to be custom molded to conform to the specific shape of the user's foot 5. In some embodiments, selection of the insole 100 involves consideration of several factors. For example, the selection can be made based on the size of the user's foot 5, the weight of the user, or the anticipated use of the insole 100.

FIGS. 8A through 8C illustrate comparison of a user's foot 5 to a selected insole 100 to determine whether a properly sized insole 100 has been selected. FIG. 8A illustrates an example of a properly sized insole 100 as compared to the user's foot 5. FIG. 8B provides an example of an insole 100 that is too small when compared to the user's foot 5. The toes of the user's foot 5 fall on top of, over, or across the outline of the toe edge of the insole 100. When comparison of the insole 100 and the foot 5 indicates that the selected insole 100 is too small, a larger sized insole 100 should be chosen. FIG. 8C illustrates an example of an insole 100 that is too large as compared to the user's foot 5. For example, as shown in FIG. 8C, if there is more than one half-inch space between the end of the user's toes and the toe edge of the insole 100, the selected insole 100 is too large and a smaller sized insole 100 should be selected.

Returning to FIG. 7, the selection of the insole 100 performed at block 704 may be made, in part, based upon a user's weight. For example, a thicker, or more rigid, insole 100 may be selected to accommodate a heavier user. In some embodiments, the selection of the insole 100 also may consider, in part, the intended use of the insole 100. For example, one type of insole 100 may be provided for distance runners, another type of insole 100 may be provided for general athletes, and another type of insole 100 may be provided for general non-athletic use.

At block 706, the selected insole 100 is heated. The insole 100 can be heated to a temperature in the range of about 120° C. to about 140° C. (for example, about 127° C.) for a range of about three to five minutes (for example, about four minutes). In some embodiments, the insole 100 is heated in a heater 200.

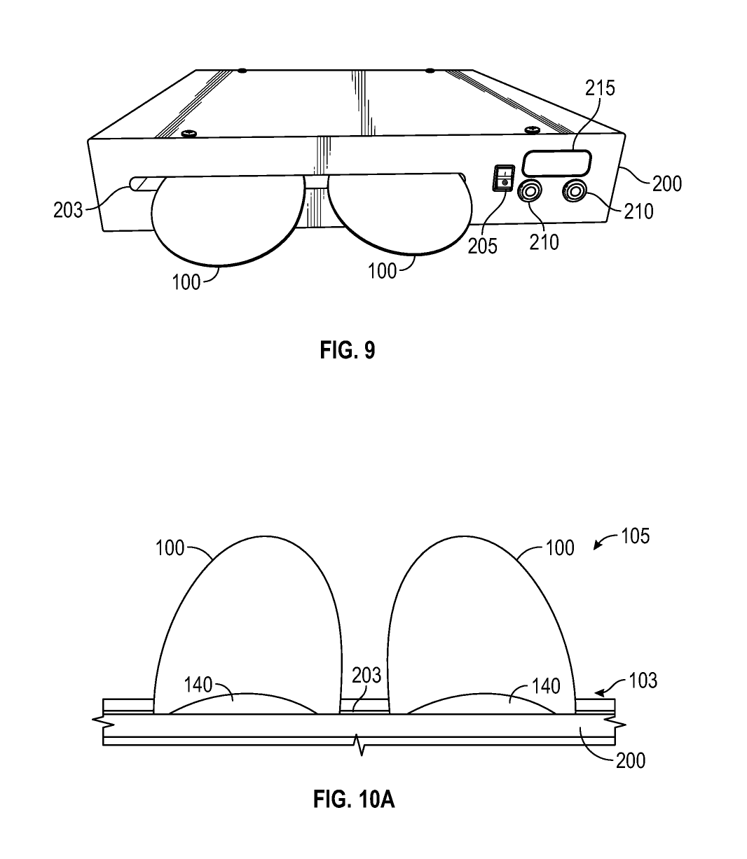

FIG. 9 illustrates an example of a heater 200 configured to heat the insoles 100 according to one embodiment. The heater 200 includes a slot 203 into which the insoles 100 can be inserted into an interior region of the heater 200. The heater 200 includes a heating element (not shown) within the interior region of the heater 200. In some embodiments, the heating element is a resistive wire heater. In some embodiments, the heating element is similar to that used in a traditional oven. The heating element may be positioned above and/or below the insoles 100. In some embodiments, the heating element includes a heated plate that is pressed against the insoles 100. A single heated plate may be positioned above and/or below the insoles 100. In some embodiments, the heated plate is positioned below the insoles 100 and a pillow positioned above the insoles 100 presses the insoles 100 into the heated plate. The heater 200 may also include an on/off switch 205, one or more heater controls 210, and a display 215. The one or more heater controls 210 may allow a user to select between one or more preset heating cycles, or to adjust the heating temperature and/or heating time manually. The display 215 can be configured to display the desired heating temperature, the current internal temperature of the heater 200, and/or the heating duration. It will be appreciated that the heater 200 shown in FIG. 9 is merely one embodiment that can be used with the method 700. A person skilled in the art will understand that other types of heaters or methods for heating the insole 100 may be used with method 700 without departing from the scope of this disclosure.

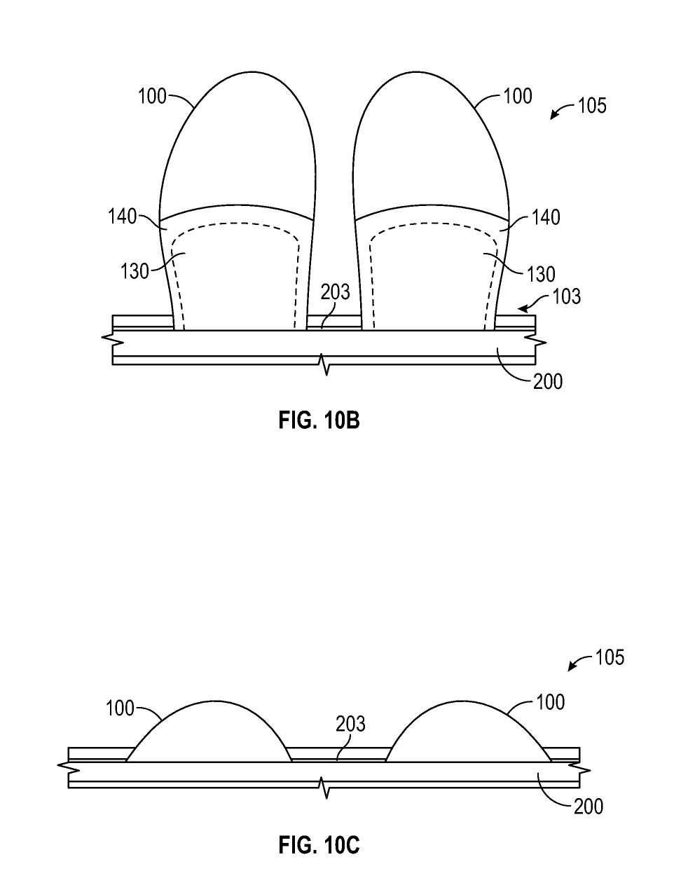

FIGS. 10A through 10C illustrate proper and improper insertion of the insoles 100 into the heater 200 according to one embodiment. In some embodiments, proper heating of the insoles 100 involves heating only the portion of the insole 100 that includes the heat moldable rigid layer 130. For example, only the rearfoot area 101 and the midfoot area 103 of the insole 100 are inserted into the heater 200. FIG. 10A illustrates an example where the insoles 100 are inserted into the heater 200 only as far as necessary. As shown, the forefoot area 101 and a very small portion of the midfoot area 103 are positioned outside of the heater 200. The remainder of the midfoot area 103 and the rearfoot area 101 are inserted into the heater 200. Accordingly, only the portions of the insole 100 that include the heat moldable rigid layer 130 are heated. FIG. 10B illustrates an example where the insole 100 is not sufficiently inserted into the heater 200. As shown, a large portion of the midfoot area 103, including a portion of the rigid layer 130, is not inserted into the heater 200. When this occurs, a portion of the rigid layer 130 is not heated and thus cannot be properly molded to the user's foot 5. FIG. 10C illustrates an example where too much of the insole 100 is inserted into the heater 200. As shown, only a small portion of the forefoot area 105 of the insole 100 is extending out of the heater 200. This may be problematic because the heater 200 is heating portions of the insole 100 that do not require heating.

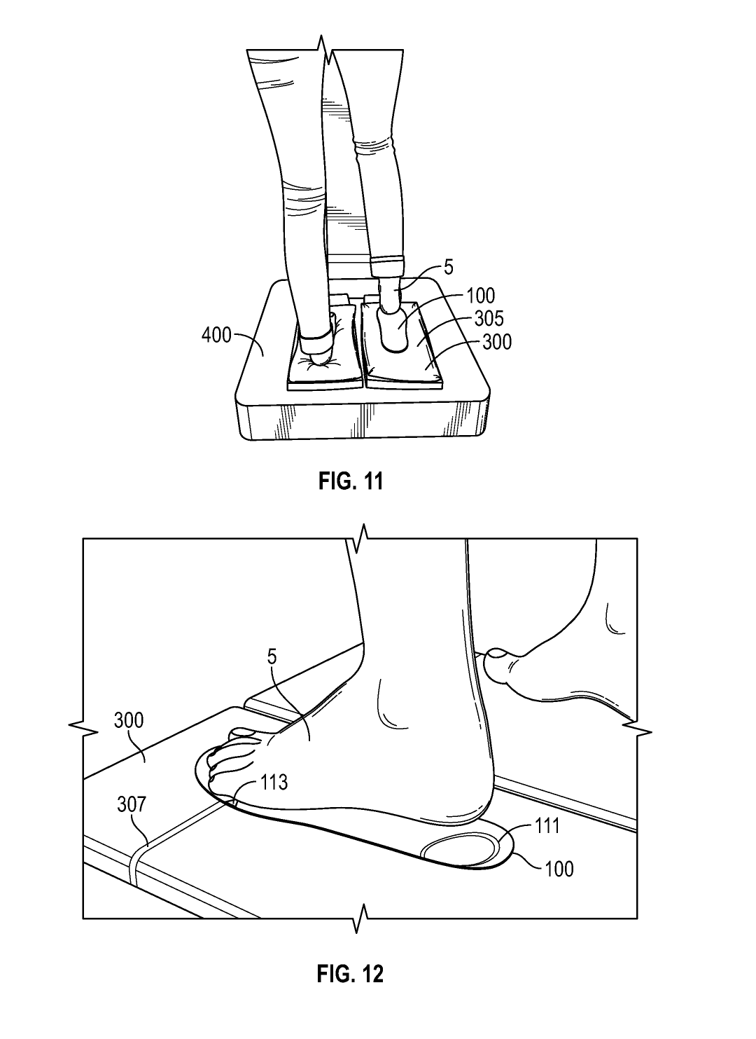

Returning to FIG. 7, at block 708, the heated insole 100 is positioned on the top surface 305 of the molding device 300 in preparation for molding. FIG. 11 illustrates an example of the relative positioning of the user, the user's foot 5, the heated insole 100, and the molding device 300 in preparation for molding. As shown, two molding devices 300 (one for each foot) are placed in a molding stand 400. The user stands with his or her left foot 5 on the left molding device 300 and his or her right foot 5 lifted above the top surface 305 of the right molding device 300. The right heated insole 100 is placed on the top surface 305 of the right molding device 300 below the user's foot 5. Although FIG. 11 illustrates an example where a user is preparing to mold a right-footed insole 100, it will be understood that the example can be reversed and applied to the positioning for molding a left-footed insole 100.

FIG. 12 provides a detailed view of the alignment of the heated insole 100 on top of a molding device 300 and below the user's foot 5. Front alignment guides 113 on the cover layer 110 of the insole 100 (also shown in FIG. 2A) are aligned with the alignment guides 307 (also shown in FIG. 3E) on the top surface 305 of the molding device 300. In some embodiments, this ensures that the heated insole 100 is positioned correctly on the molding device 300 so as to properly be molded when the movable portion 310 of the molding device 300 is in both the first and second positions. The heel alignment guide 111 on the top surface of the insole 100 is positioned below the heel.

Once the heated insole 100 and user have been properly positioned relative to the molding device 300, the user's foot 5, is placed into contact and aligned with the insole 100. At block 710, the user's foot 5 can be correctly positioned by aligning the heel of the user's foot 5 with the heel alignment guides 111 on the insole 100, and then ensuring that the user's foot 5 is centered along the width of the insole 100.

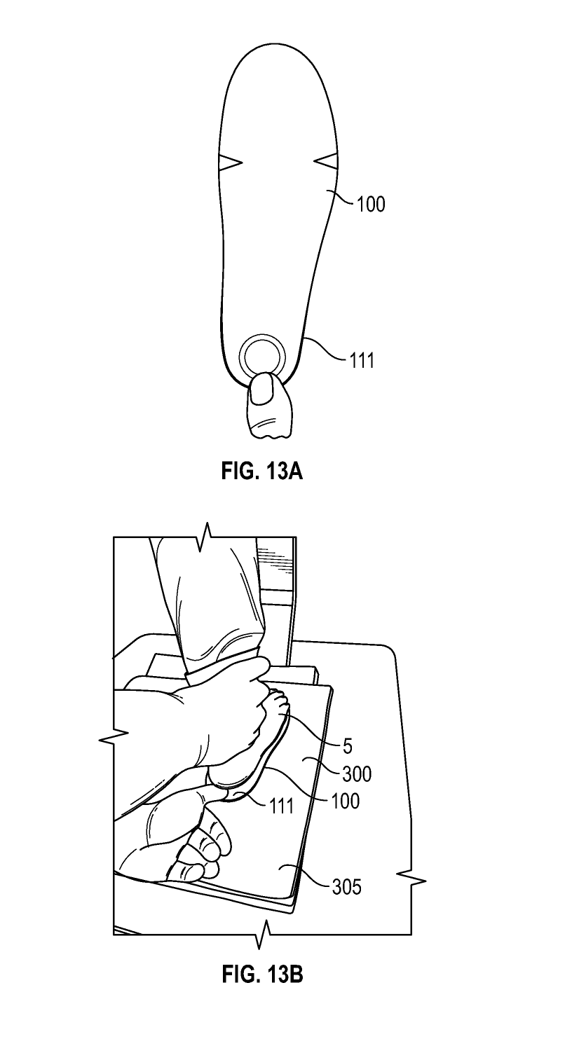

FIGS. 13A and 13B illustrate the use of an example heel alignment guide 111 on the moldable insole 100 to properly align the user's foot 5 relative to the moldable insole 100 during the molding process 700 according to on embodiment. As shown in FIG. 13A, an employee or other person assisting the user, may place the thumb of one hand at the bottom of the circles of the heel alignment guide 111. The thumb may provide a backstop against which the user's foot 5 will be positioned. As shown in FIG. 13B, the employee or other person assisting the user uses his or her other hand to guide the placement of the user's foot 5 onto the heated insole 100. The user's heel is placed against the employee's thumb, and the employee ensures that foot 5 is centered on the insole 100 across the insole's width.

Returning again to block 710 of the method 700 illustrated in FIG. 7, once the user's foot 5 is aligned and placed onto the heated insole 100 with the user's weight applying downward pressure, the heated insole 100 begins to conform to the unique shape of the user's foot 5. In some embodiments, after the foot 5 is properly placed and aligned on the insole 100, the user stands with weight distributed evenly on both feet 5, looking straight ahead, for example, for approximately ten seconds to allow time for the insole 100 to mold to the user's foot 5. In some embodiments, during this step the user may stand with weight evenly distributed between each foot 5, looking straight ahead, for example, for between about five and about thirty seconds.

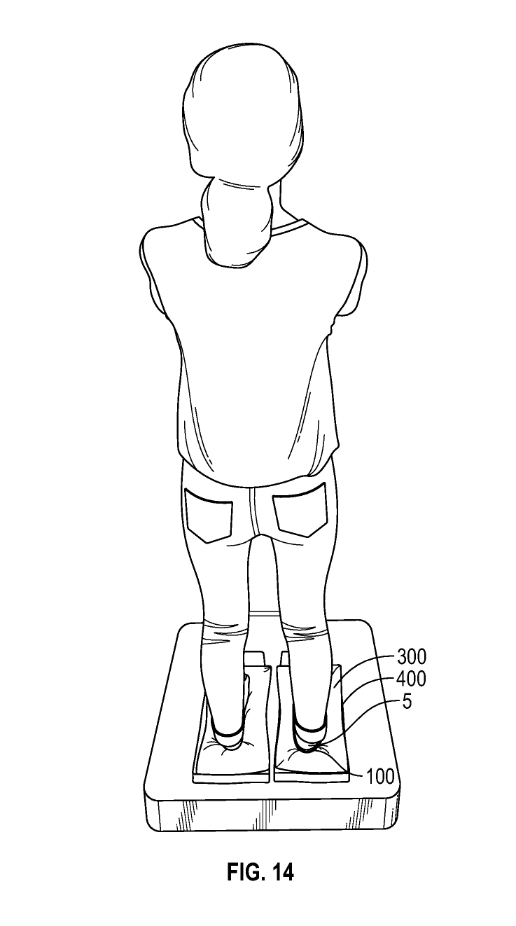

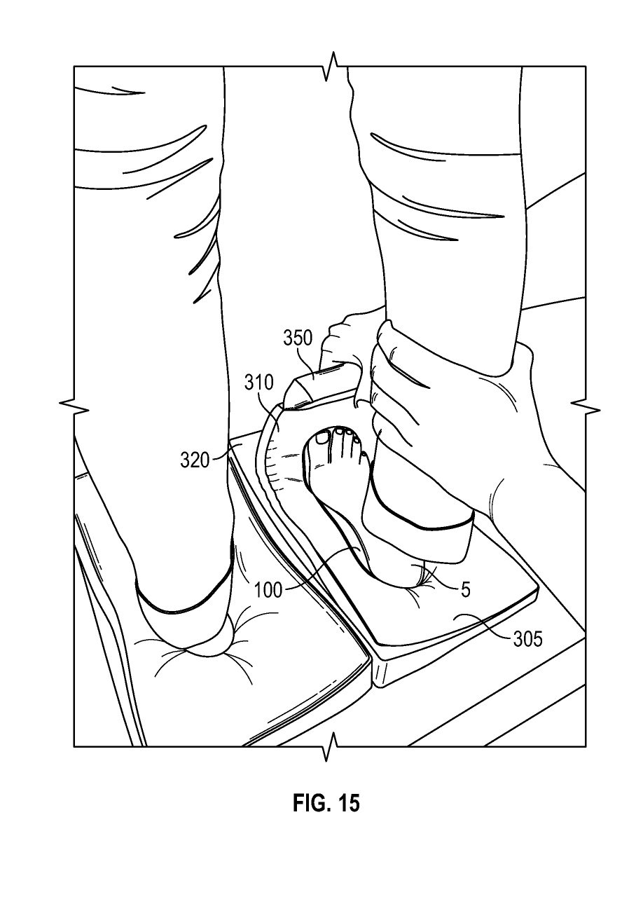

At block 712, the molding device 300 is used with the movable portion 310 in the first position to mold a portion of the insole 100. In some embodiments, with the movable portion 310 in the first position, the user shifts his or her weight to his or her heels and distributes the weight equally between each foot 5. That position may be held, for example, for approximately ten seconds, while continuing to look straight ahead. In some embodiments, this is accomplished by having the user grip the handle 420 of the molding stand 400 and lean backward, placing weight onto his or her heels, for example as shown in FIG. 14. After shifting weight to the heels for, for example, ten seconds, the user is directed to return to an upright position with weight distributed equally. In some embodiments the user may shift weight to the heels, for example, for between about five and about thirty seconds before returning to an upright position.

At block 714, the movable portion 310 of the molding device 300 is adjusted to the second position to mold a portion of the insole 100. FIG. 15 illustrates an example positioning of a user and the molding device 300 with the movable portion 310 in the second position. As shown, an employee or other person assisting the user, uses one hand to grab the handle 350 on the distal end of the moveable portion 310 and pulls the moveable portion 310 straight back towards the user's shin, pulling the toes of the user's foot 5 back and up. With his or her other hand, the employee or other person assisting the user can hold the user's ankle or lower leg to ensure that the user's ankle and foot alignment remains neutral throughout the molding process. This positioning is held for, for example, approximately ten seconds to allow the insole 100 to conform to the shape of a user's foot 5. In some embodiments, this position is held for, for example, between about five and about thirty seconds. After the designated time, the movable portion 310 of the molding device 300 is returned to the first position by lowering the handle 350 until the movable portion 310 rests on top of the fixed portion 320. This allows the user's toes to come back down to a normal standing position. At this point, the user lifts his or her foot off the insole 100 and the insole 100 is removed and allowed to cool. As the insole 100 cools, the rigid layer 130 hardens and retains the newly molded shape.

At block 716, the now molded insole 100 is checked for quality. In some embodiments, this involves visually inspecting the molded insole 100, placing the insole 100 in a user's shoe to check for comfort, and/or checking the molded insole against a quality control tool.

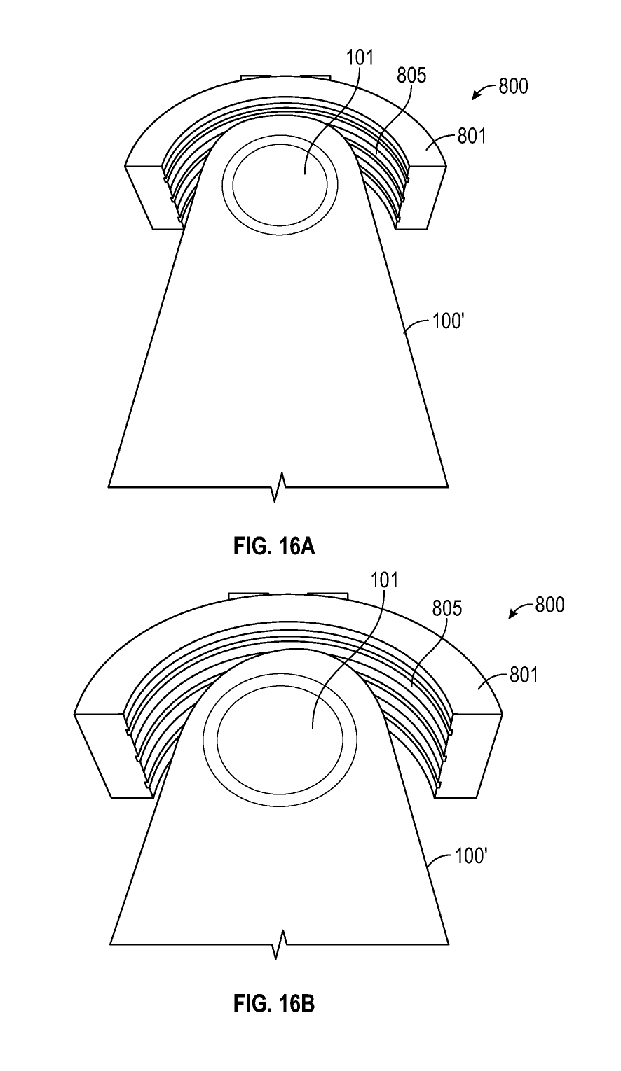

FIGS. 16A and 16B illustrate the use of an example quality control tool 800 to check that the heel portion 101 of a molded insole 100 is properly aligned and level according to one embodiment. The quality control tool 800 includes a semicircular body 801 with one or more parallel lines 805 inscribed on an inside wall of the body 801. Each of the interior lines 805 may be a different color to allow a user to easily follow each single interior line 805. The heel area 101 of the molded insole 10 can be inserted into the interior region of the body 801 and the compared against the plurality of lines 805 to determine whether the heel area 101 is properly aligned and level. In some embodiments, as shown in FIG. 16A, the edge of a properly aligned and level heel area 101 of the molded insole 100 generally follows the interior lines 805 of the quality control tool 800. This indicates that the heel cup is level. FIG. 16B shows an improperly molded insole 100 compared against the quality control tool 800. When the edge of the heel area 101 crosses through several of the interior lines 805 of the quality control tool 800, this indicates that the insole 100 has not been properly molded.

If the quality of the molded insole 100 is determined to be insufficient, the molded insole 100 may discarded and the method 700 may begin again with a new non-molded insole 100. If the quality of the molded insole 100 is determined to be sufficient, method 700 ends.

The toe edge of the molded insole 100 may be trimmed before use. This may be done by placing the molded insole 100 on top of or below the insole from the user's shoe. The user or employee assisting the user can then trim the toe edge of the molded insole with scissors using the insole from the user's shoe as a template. It may not be necessary to trim the heel edge of the molded insole 100. The molded insole 100 is then ready for insertion into a user's shoe and is ready for use.

According to at least one of the disclosed embodiments, an insole 100 can be efficiently and accurately molded by a molding device 300. The molding device 300 include a movable portion 310 that is movable between a first position, useful for molding at least a rearfoot and/or midfoot portion of the insole 100, and a second position, useful for molding at least a forefoot and/or midfoot portion of the insole 100.

While the above description has pointed out features of various embodiments, the skilled person will understand that various omissions, substitutions, and changes in the form and details of the device or process illustrated may be made without departing from the scope of the appended claims.

What is claimed is:

1. A molding device for molding a shoe insole, comprising:
a foam layer;
a gel layer placed over the foam layer;
a flexible cover configured to enclose the foam layer and the gel layer, wherein the flexible cover comprises a movable portion and an intermediate portion placed below the movable portion, wherein the intermediate portion is placed between a portion of the gel layer and a portion of the foam layer, and wherein the flexible cover includes a surface that contacts a top of the gel layer;
wherein the gel layer is configured to elastically support the shoe insole via the surface of the flexible cover; and
wherein the movable portion is configured to move the portion of the gel layer between a first position where the movable portion contacts the intermediate portion and a second position where the movable portion is separated from the intermediate portion.

2. The molding device of claim 1, further comprising a handle attached to a distal end of the movable portion, the handle configured to facilitate movement of the movable portion between the first position and the second position.

3. The molding device of claim 2, wherein the handle has at least one hole passing through the handle.

4. The molding device of claim 1, wherein the gel layer comprises a material with a hardness that approximates muscles tissue.

5. The molding device of claim 1, wherein the gel layer comprises a material with a Shore hardness in the range of about 00-05 and about 00-30.

6. The molding device of claim 1, wherein the foam layer comprises a viscoelastic foam material.

7. The molding device of claim 1, wherein the thickness of the gel layer is less than or equal to half the thickness of the foam layer.

8. The molding device of claim 7, wherein the thickness of the gel layer is approximately 30 mm, and wherein the thickness of the foam layer is approximately 70 mm.

9. The molding device of claim 1, wherein the gel layer comprises a plurality of layers.

10. The molding device of claim 1, wherein the length of the foam layer is approximately equal to the length of the gel layer, and wherein the width of the foam layer is approximately equal to the width of the gel layer.

11. The molding device of claim 1, wherein the cover is configured to be removable.

12. A method of custom molding a shoe insole, comprising:
placing the insole on a molding device, wherein the molding device includes a foam layer, a gel layer, and a flexible cover;
a) pressing the insole between a user's foot and a surface of the molding device with the molding device in a first position, wherein the surface contacts a top of the gel layer; and
b) pressing the insole between the user's foot and the surface of the molding device with the molding device in a second position different from the first position.

13. The method of claim 12, further comprising heating the insole the insole to a temperature in the range of approximately 120° C. and approximately 140° C. for between about three minutes and about five minutes;

14. The method of claim 12, wherein the molding device further comprises:
a movable portion including at least the distal end of the gel portion; and
a handle at the distal end of the movable portion.

15. The method of claim 12, wherein the a) pressing comprises standing the user with weight distributed to the heels of the user.

16. The method of claim 12, the b) pressing comprises standing the user with weight distributed evenly across the feet of the user.

17. The method of claim 12, further comprising moving the movable portion of the molding device between the first position and the second position by pulling the handle toward the shin of the user.

18. The method of claim 12, further comprising standing the user on a molding stand, wherein the molding stand comprises a base with a recess configured therein, the molding device positioned within the recess, and an extension member that extends upward away from the base to a handle, the handle configured to provide support for a user standing on the molding device.

19. A shoe insole molded by the method of claim 12.

20. A molding device for molding a shoe insole, comprising:
a gel layer; and
a flexible cover configured to enclose the gel layer, wherein the flexible cover includes a surface that contacts a top of the gel layer, wherein the gel layer is configured to elastically support the shoe insole via the surface of the flexible cover.

21. The molding device of claim 20, further comprising a foam layer placed below the gel layer and within the flexible cover.

22. The molding device of claim 21, wherein the flexible cover further comprises a movable portion and an intermediate portion placed below the movable portion, wherein the intermediate portion is placed between a portion of the gel layer and a portion of the foam layer.

23. The molding device of claim 22, further comprising a handle attached to a distal end of the movable portion, the handle configured to facilitate movement of the movable portion between a first position and a second position.

24. The molding device of claim 23, wherein the gel layer comprises a material with a Shore hardness in the range of about 00-05 and about 00-30.

25. The molding device of claim 24, wherein the gel layer comprises a plurality of layers.
